(19) United States
(12) Patent Application Publication
(10) Pub. No.: US 2005/0230958 A1
(43) Pub. Date: Oct. 20, 2005

(54) Paper

(76) Inventors: Gerald Payne, Somerset (GB); Paul Howland, Andover (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/518,400

(22) PCT Filed: Jun. 19, 2003
(86) PCT No.: PCT/GB03/02625

§ 371 Date: Jan. 19, 2005

(30) Foreign Application Priority Data
Jun. 19, 2002 (GB) 0214161.2

(51) Int. Cl. B42D 15/00

(52) U.S. Cl. 283/72

(57) ABSTRACT

The invention relates to improvements in paper and in particular to paper for use in making labels or packaging, having a removable element. Paper having first and second opposing surfaces, and an elongate security element at least partially embedded in the paper such that when a tearing force is applied to the elongate element, a removable portion is separated from the rest of the paper.

The invention relates to improvements in paper and in particular to paper for use in making labels or packaging, having a removable element.

Security elements or threads have long been used in security documents, such as banknotes, passports and the like to provide an anticounterfeiting feature. Such security elements, commonly consist of a strip of transparent polyester which bears a metal layer, which may or may not be partially demetallised to provide clear indicia. Security elements may in addition, or alternatively, have other security features and are usually wholly embedded within the security paper, or partially embedded so that they are revealed at spaced intervals at windows in one or both surfaces of the paper. The elements are embedded in a manner that the they cannot be easily removed. This is so that the elements cannot be extracted and used for counterfeiting purposes.

This use of security elements has recently been extended to secure labels which can be applied to the packaging of, or directly to valuable products for retail or pharmaceuticals to provide an indication of the genuine nature of the goods. An example of such a label is described in EP-A-0773527.

Tear tapes are commonly used with a range of types of packaging such that once the packaging has been opened, it cannot be resealed. Thus they have a dual role, in providing permanent evidence of tampering and as an anticounterfeit feature to prevent the packaging from being re-used on counterfeit articles. Tear tapes are commonly strips of plastic or textile materials which are stronger than the base packaging. Sometimes printed information is applied to the tear tapes, such as the name of the goods or opening instructions.

Tear tapes, however, are never incorporated into paper in the same manner as security elements. Instead, they are applied to the surface of the packaging as a subsequent conversion process.

FR-A-2784779 describes a label which has a tampering resistant band. The band forms part of the label itself and can be torn away from the rest of the label. The label is affixed to a tube or pill dispenser which is closed by a lid such that the tear off strip covers the joint between the lid and the tube. In order to open the tube it is necessary to tear off the band, revealing the primary opening of the package.

DE-A-10017141 describes an information carrier which is intended for use in the motor vehicle industry. This has a base layer bearing printed information and it at least two film pieces detachably disposed on the base layer above the printed information.

FR-A-280393A also describes a tamper proof label which is removable part of the label itself.

It is an object of the present invention to combine the concepts of secure labels and tear tapes to provide paper, which can be used for making packaging or labels, which has a removable element either to provide evidence of tampering or to provide a vehicle for verification.

The invention therefore provides paper having first and second opposing surfaces, and an elongate element, such that when a tearing force is applied to the elongate element, a removable portion is separated from the rest of the paper characterized in that the element is a security element having at least one verifiable authenticating feature, and the security element is at least partially embedded with in the paper.

The invention will now be described, by way of example only, with reference to the accompanying drawings in which:—

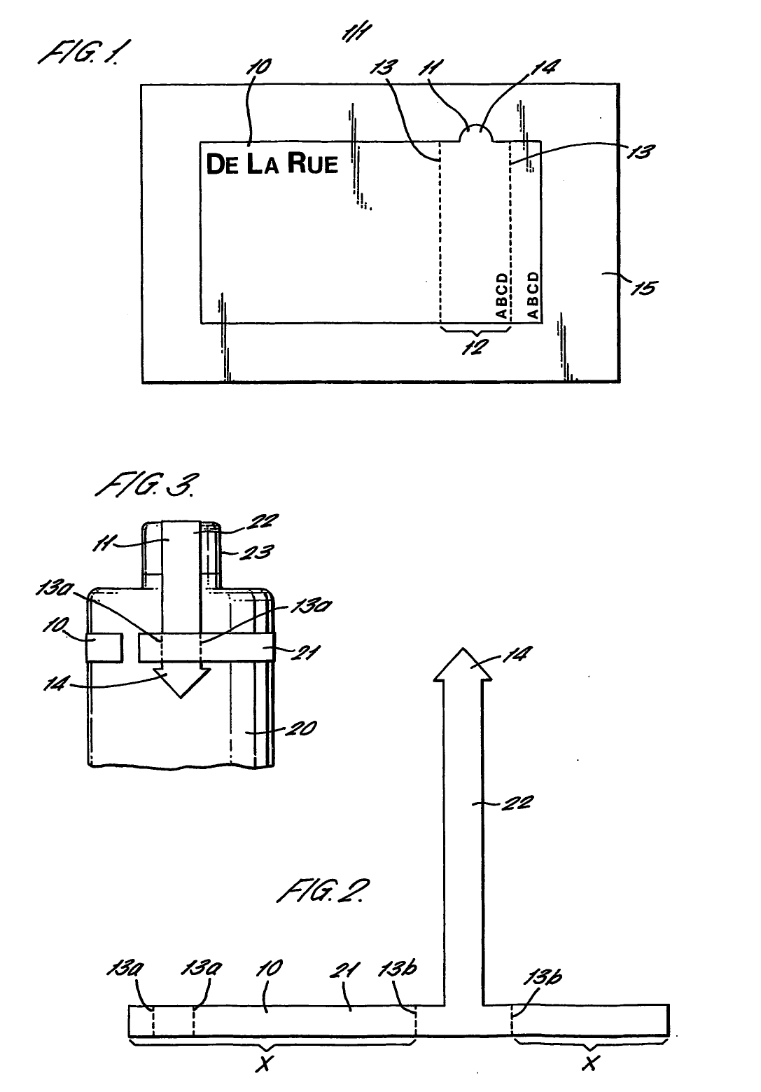

FIG. 1 is a plan view of a label made from paper according to the present invention;

FIG. 2 is a plan view of a alternative label to that shown in FIG. 1; and

FIG. 3 is a pictural representation of the label of FIG. 2 applied to a bottle.

A label 10 made from paper according to the present invention is illustrated in FIG. 1 and consists of a paper substrate having two opposing surfaces. A first surface can be used for bearing printed information or indicia and the second surface has a layer of an adhesive applied thereto. A suitable adhesive would be Pressen 1456 or National DT 38-3624, which are hot melt and are pressure sensitive adhesive respectively although the adhesive used would very much depend on the intended use of the label. An elongate flexible security element or thread 11 is wholly embedded within the paper layer as shown in FIG. 1. Alternatively it may be only partially embedded so that it is exposed in windows at the first surface. A suitable methods of embedding security elements 11 is described in EP-A-0059056, EP-A-070172, EP-A-0687324, EP-A-0625431, EP-A-0229645 and EP-A-0860298. A typical paper weight for a label containing a security element is 90 gsm, although a person skilled in the art would recognise that a wide range of paper weights could be used.

In the example shown in FIG. 1 it is intended that the security element 11 can be used to remove a portion 12 from the label 10 between the two lines of perforations 13. To enable this to occur, the adhesive is applied to the second surface of the paper layer only in the regions outside the perforation 13. Additionally, the paper substrate includes a small tab 14 projecting from one edge of the label 10 surrounding one end of the elongate element 11.

Thus, when the label 10 is applied to a surface 15, for example the side of the package, a bottle, or the like, it only adheres to the surface 15 in the regions outside the removable portion 12. To remove the removable portion 12, a user grasps the tab 14 and pulls it backwards and upwards. As the security element 11 is stronger than the paper substrate. The label 10 tears along its weakest points, i.e. the perforations 13, enabling the portion 12 to be separated from the rest of the label 10 and removed.

Such a label 10 provides a number of advantages. Firstly, the label 10 contains a security element 11 which enables a consumer to verify that the goods to which the label 10 is applied are genuine. Secondly as the security element 11 also functions as a tear tape, the verifiable section of the label 10, i.e. that containing the security element 11, is removable and can be used independently from the goods by the consumer for another benefit e.g. to exchange it for free goods or a bonus of some description.

To provide a further benefit, both the removable portion 12 and the rest of the label 10 may be provided with a readable code, both of which are related either directly via a database or by a mathematical algorism which is secret to the public. This would give the retailer or manufacturer of the product a means of tracking the genuine goods.

As mentioned above, the security element 11 may be partially exposed in windows, which provides the ability of including further verification information or features. Such security elements, 11 may take a number of forms. It preferably comprises a base substrate of PET or another similar material, which may be transparent. The substrate may be wholly metallised, include metal, demetallised or printed indicia, holographic, thermochromic or liquid crystal, machine readable, magnetic or a variety of other security features.

The perforations 13 illustrated are optional. If the adhesive used is strong enough, the paper substrate will tear reasonably easily along the boundary between the adhesive and non adhesive regions. As a further alternative, small cuts may be made on either side of the tab 14, to encourage the paper to start tearing when a pulling force is applied to the security element 11.

In a further embodiment of the invention, it is envisaged that the removable portion 12 comprises just the security element 11 which can be extracted from the label 10 without removing any other parts of the label. When embedding security elements according to EP-A-0059056 an adhesive is typically applied to the element 11 before embedment which helps to prevent it from being removed from the finished paper, as the paper fibres adhere to the element 11 during the paper formation. If no adhesive is present, or is present on one side only of an oriented element 11, it is possible for the element 11 to be extracted from the paper. In this embodiment of the invention, the security element 11 itself preferably bears verifiable features and is exposed at windows in the first surface of the label 10. Where the element 11 bears no adhesive, it can be extracted without affecting the paper bridges between the windows. If the element 11 carries an adhesive on one of its side, the paper bridges between the window may need to be broken to enable the element 11 to be removed. Also in this embodiment, the adhesive layer may cover all of the second surface of the label substrate and need not be absent in the area of the removable portion 12 which equals the element 11.

The element 11 may also be exposed along one surface across the full width of the label, with only the edges only of the element 11 embedded within the paper.

In a further embodiment of the invention, the removable portion 12 is located at an edge of the label 10. Such an edge removable portion 12 may have no adhesive applied to its second surface, in which case it forms a free flap. Alternatively a light tack (re-positionable) adhesive could be applied to the portion 12 so that it can still easily be removed, but is held in position prior to removal to prevent it from getting damaged or folded.

As an alternative to the tab 14, the label 10 may have a small cut out at the same position as the tab in the embodiment of FIG. 1, in which the end of the security element 11 is exposed and left free. This enables the user to grasp the element 11 for extraction. This can be achieved by the process described in our co-pending application (number not yet issued) entitled “Improvements in Substrates”.

In a further alternative version of the present invention, as shown in FIGS. 2 and 3, a label 10 can be formed from the paper into a shape which is suitable for applying to the cap 23 of a container, such as a bottle 20.

In the embodiment illustrated, the label 10 has an elongate portion 21 or band, the second surface of which carries and adhesive in the regions marked X. The second surface of the remaining part of the label 10, which constitutes the removable portion 22, may carry no adhesive or a light tack adhesive. The band 21 of the label 10 is wrapped around the bottle 20 with the removable portion 22 extending from one side of the bottle 20 over the bottle cap 23 and firmly secured underneath the band 21 which adheres to the removable portion 22 between the two lines of perforations 13a.

Before opening the bottle 20, a user grasps the tab 14 and pulls it upwardly so that the label 10 tears along the perforations 13a on the one side of the bottle. As the removable portion 22 is peeled back away from the lid 23, the label 10 is further torn at the second set of perforations 13b so that the removable portion 22 is entirely removed from the bottle 20 and separated from the rest of the label 10.

Thus, such a label 10 provides a tamper evident feature as the label 10 is destroyed by the removal of the removable portion 22 in order to gain access of the bottle 20. The removable portion 22 can also be used for marketing or record purposes as described above.

This type of label 10 may also be used in medical applications where the bottle 20 contains a particular drug or vaccine and the removable portion 22 may be kept with a patient's file as a record of the drug and that used. Alternatively, the removable portion 22 could constitute a part of a test connected with the contents of the bottle 20.

Thus, the security element 11 has a dual purpose. The strength of the element 11 helps to break the seal and enable the removal of the removable portion 22. It can also bear security features to provide verification both in situ and after removal of the removable portion 22.

The security element 11 may comprise both a thermochromic layer and a continuous conductive layer. When a current is applied across the lid with an appropriate checking device, the thermochromic material changes colour. Any tampering with the element 11 is likely to involve cutting it, which will break the conductive circuit and the electro-thermochromic system will not work.

Alternatively the security element 11 may contain a thermochromic layer that changes colour irreversibly when heated above the maximum temperature permitted by the bottle contents.

Alternatively the security element 11 may contain a thermochromic layer that changes colour reversibly when heated by hand to act as an authenticating device.

The security element 11 may contain colour shift features, holograms or the like that make it difficult to counterfeit but easy for the user to verify.

The security element 11 may alternatively contain inspector level security including phosphorescent, luminescent, micro-print and magnetic features, which require additional equipment or apparatus to be deleted or activate the feature.

The label 10 construction can optionally include:
electrotype patterns that enable the public to verify the genuine article and which may also contribute to its frangibility;
an adhesive that is carefully chosen so as to ensure that attempts to peel the label off result in the label being damaged;
sensitizers that alert the user to attempts to remove the label with solvents;
secure print designed to convey important information or limited public security;
variable information such as batch number and use by date;
sensitizers chosen to prevent the variable data from being tampered; or
frangible coatings which prevent variable data from being scratched off without exposing coloured or fluorescent under layers.

The various alternative features described above may be used individually, in multiples or with different features on one label 10.

Paper according to the present invention can be used to make self adhesive labels as described above, or other forms of labels and additionally packaging. The packaging may comprise paper according to the present invention either by itself or laminated to additional sheets of paper or card or other materials.

1. Paper (10) having first and second opposing surfaces, and an elongate element (11) such that when a tearing force is applied to the elongate element (11), a removable portion (12) is separated from the rest of the paper (10) characterized in that the element (11) is a security element (11) having at least one verifiable authenticating feature, and the security element (11) is at least partially embedded with in the paper (10).

2. Paper (10) as claimed in claim 1 in which the removable portion (12) is the elongate element (11).

3. Paper (10) as claimed in claim 1 in which the removable portion (12) comprises a section of the paper (10) and the elongate element (11).

4. Paper (10) as claimed in claim 1 in which the elongate element (11) is wholly embedded in the paper (10)

5. Paper (10) as claimed in claim 1 in which the elongate element (11) is exposed at windows in the first surface of the paper (10).

6. Paper (10) as claimed in claim 1 in which one side of the elongate element (11) is wholly exposed across the full width of the paper (10).

7. Paper (10) as claimed in claim 1 further comprising at least one line of perforations (13) separating the removable portion (12) from the rest of the paper (10).

8. Paper (10) as claimed in claim 3 in which the removable portion (12) is an edge portion of the paper (10).

9. Paper (10) as claimed in claim 1 in which the removable portion (12) comprises a middle section of the paper (10).

10. Paper (10) as claimed in claim 1 in which the removable portion (12) comprises legible indicia.

11. Paper (10) as claimed in claim 10 in which the legible indicia comprises printed information.

12. Paper (10) as claimed in claim 10 in which the legible indicia is formed from demetallised or metallised alphanumeric characters on the elongate element (11).

13. Paper (10) as claimed in claim 1 in which the elongate element (11) is machine readable.

14. Paper (10) as claimed in claim 1 in which the elongate element (11) incorporates an activatable security feature.

15. Paper (10) as claimed in claim 1 in which the elongate security element (11) comprises one or more of the same or different security features.

16. Paper (10) as claimed in claim 1 in which an end of the elongate element (10) is enclosed in a tab (14) projecting from an edge of the paper.

17. Paper (10) as claimed in claim 1 in which an end of the elongate element (11) is exposed in a cut out portion at an edge of the paper (10).

18. A label (10) made from paper according to claim 1.

19. A label (10) as claimed in claim 18 further comprising an adhesive applied to at least a portion of the second surface of the paper (10), such that when the label (10) is adhered to the surface and a tearing force is applied to the elongate element (10), a removable portion (12) is separated from the rest of the label (10).

20. A label (10) as claimed in claim 19 in which no adhesive is applied to the second surface in the region of the removable portion of the label (10).

21. A label (10) as claimed in claim 19 in which a low tack adhesive is applied to the second surface of the removable portion of the label, said adhesive being of a lower tack than the adhesive applied to other parts of the second surface of the paper (10).

22. Packaging made from paper (10) as claimed in claim 1.
